(19) United States
(12) Patent Application Publication
(10) Pub. No.: US 2008/0291187 A1
(43) Pub. Date: Nov. 27, 2008

(54) DRIVE METHOD AND DISPLAY DEVICE OF DISPLAY ELEMENT

(75) Inventors: Masaki NOSE, Kawasaki (JP); Toshiaki YOSHIHARA, Kawasaki (JP); Hisashi YAMAGUCHI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Fujitsu Limited, Kawasaki-shi (JP)

(21) Appl. No.: 12/185,488

(22) Filed: Aug. 4, 2008

Related U.S. Application Data
(63) Continuation of application No. PCT/JP2006/306691, filed on Mar. 30, 2006.

(51) Int. Cl. G09G 5/00; G09G 3/36

(52) U.S. Cl. 345/205; 345/90

(57) ABSTRACT

In a method of driving a display element, the display element has a plurality of first electrodes and a plurality of second electrodes intersecting each other in mutually opposing state, and a display medium between each of the first electrodes and each of the second electrodes. The display medium is driven by a first driver coupled with the first electrodes and a second driver coupled with the second electrodes, and one of the first and second drivers is used as a scan driver whereas the other of the first and second drivers is used as a data driver. Of the partial rewritten areas in the existing display image, the area having a smaller number of electrodes corresponding thereto is selected as the scan driver.

### CROSS-REFERENCE TO RELATED APPLICATION

This application is a continuation application and is based upon PCT/JP2006/306691, filed on Mar. 30, 2006.

### BACKGROUND

The embodiment relates to a drive method and a display device of display element, in particular to a technology for driving display element such as cholesteric liquid crystal for displaying a stationary image.

In recent years, a technology is being rapidly developed in the field of electronic papers in various corporations and research institutes including universities. As promising application markets for electronic papers, various applications have been proposed such as e-books (electronic books), sub-displays for mobile terminals and displays for IC cards.

Conventionally, a method using a cholesteric liquid crystal is known to be advantageous for application to electronic papers. Cholesteric liquid crystal has excellent characteristics such as semi-permanent display image retaining capability (memory capability), clear color display, high contrast and high resolution image etc. Moreover, by laminating three display layers reflecting colors R (red), G (green) and B (blue), respectively, cholesteric liquid crystal enables sharp full color display to be realized.

Cholesteric liquid crystal is sometimes referred to as chiral nematic liquid crystal since relatively large amount (a few dozens %) of chiral additive (also called chiral agent) can be added to a nematic liquid crystal to form a spiral cholesteric phase of nematic liquid crystal molecules.

Since a cholesteric liquid crystal material is a liquid crystal having memory characteristics, and can be driven in an inexpensive and simple matrix drive mode, it is relatively easy to realize, for example, a large display of A4 size or larger. Further, in the case of the cholesteric liquid crystal, only the renewal of the content of display (rewriting an image) needs electric power, and once the image has been rewritten, the image is retained even when the electric power source is entirely turned off.

First, an example of method for driving cholesteric liquid crystal as an example of display element according to the embodiment will be disclosed.

FIG. 1A and FIG. 1B are views useful for explaining orientation states of a cholesteric liquid crystal, wherein FIG. 1A shows a planar state and FIG. 1B shows a focal conic state.

When no electric field is applied, cholesteric liquid crystal can take one of two stable states, that is, planar state and focal conic state.

Thus, as shown in FIG. 1A, in a planar state, incident light is reflected from the liquid crystal so that reflected light can be seen with human eyes.

As shown in FIG. 1B, in a focal conic state, incident light passes through the liquid crystal, and therefore, by providing a light absorption layer separate from the liquid crystal layer, black color can be displayed in focal conic state.

Here, in planar state, light having wavelength corresponding to the spiral pitch of the liquid crystal molecules is reflected. The wavelength λ for which maximum reflection is obtained can be expressed as λ=n·p, where n is mean refractive index, and p is the spiral pitch. Reflection bandwidth Δλ increases with refractive index anisotropy Δn of the liquid crystal. Thus, by selecting the mean refractive index n of liquid crystal and the spiral pitch p, color of wavelength λ can be displayed.

FIG. 2A, FIG. 2B, and FIG. 2C are views showing voltage characteristics (relation of voltage and time) for driving the cholesteric liquid crystal, showing electric field applied to the liquid crystal for respective variations of homeotropic state, focal conic state, and planar state. Here, symbols H, FC, and P represent homeotropic state, focal conic state, and planar state, respectively.

When a strong electric field is applied to the cholesteric liquid crystal, the spiral structure of the liquid crystal molecules is completely loosened, and the transition to homeotropic state H in which all the molecules are aligned with the electric field occurs.

As shown in FIG. 2B, when the electric field is suddenly reduced to zero from the homeotropic state, the spiral axis of the liquid crystal becomes perpendicular to the electrode, and the transition to planar state P occurs in which light is selectively reflected in accordance with the spiral pitch.

On the other hand, when a weak electric field in which spiral axis of the liquid crystal molecules is barely loosened is formed and then reduced to zero, as shown in FIG. 2A, or when a strong electric field is first applied and is slowly reduced to zero, as shown in FIG. 2C, the spiral axis of the liquid crystal becomes parallel to the electrode, and the transition to the focal conic state FC occurs in which incident light is transmitted through the liquid crystal.

When electric field of an intermediate strength is applied to the liquid crystal and is suddenly removed, liquid crystals in planar state P and in focal conic state FC exist in a mixture, permitting a display in an intermediate tone.

Thus, cholesteric liquid crystal is bistable, and this phenomenon can be used to display information.

FIG. 3 is a view showing reflectivity characteristics (relation of reflectivity to voltage) of the cholesteric liquid crystal, which summarizes the voltage response of the cholesteric liquid crystal disclosed above with reference to FIGS. 2A to 2C.

As shown in FIG. 3, if the initial state is planar state P (the high reflectivity area at the left end of FIG. 3), when the pulse voltage is raised to a certain range, the transition to the drive band of focal conic state FC (the low reflectivity area of FIG. 3) occurs, and when the pulse voltage is raised further, the transition back to the drive band of planar state P (the high reflectivity area at the right end of FIG. 3) occurs.

If the initial state is focal conic state FC (the low reflectivity area at the left end of FIG. 3), as the pulse voltage is raised, gradual transition to the drive band of planar state P occurs.

In planar state P, only right hand circularly polarized light or left hand circularly polarized light is reflected and the rest of the light is transmitted, so that theoretical maximum reflectivity is 50%.

Conventionally, in a drive method of a liquid crystal display element in which information is displayed by selecting planar state and focal conic state, a fast forwarding mode of driving is proposed for rapidly operating the display element in phase transition driving (see, for example, JP-2000-171837-A).

Also, as an information display device in which full color display element can be diverted to monochromatic display element, a display device is proposed in which information is displayed in monochrome by simultaneously driving the same pixel in three display layers respectively sandwiching liquid crystal between transparent substrates for developing colors of R, G, and B (see, for example, JP-2000-194005-A).

As has been disclosed above, in recent years, electronic papers have been developed for practical use, for example, by using cholesteric liquid crystal, etc. In electronic papers, for example, rewriting function in a specified portion of the display area (partial rewriting function) is required.

Present applicant has filed a patent application (Japanese Patent Application No. 2005-099711) for a drive method of liquid crystal display element which permits partial rewriting of an image to be performed at high speed.

FIGS. 4A and 4B are views useful for explaining an example of a drive method for driving a display element in the related art proposed in Japanese Patent Application No. 2005-099711. In FIG. 4A and 4B, the reference numeral 100 denotes an original image (existing image), 121 denotes a driver IC on the scan side (scan driver), 200 denotes a driver IC on the data side (data driver), and R0 denotes partial rewrite area.

In the above-mentioned related art, in the original image shown in FIG. 4A, in order to rewrite the partial rewrite area R0 so as to display the image 200 after rewriting as shown in FIG. 4B, an image is written not by scanning the entire area on the scan side (all the scan electrodes) S10 at the ordinary speed, but by scanning, for example, the area on the scan side including the rewrite area R0 (scan electrodes corresponding to the rewrite area R0) S12 at the ordinary speed to rewrite an image (rewriting), and at the same time, scanning the area on the scan side not including the rewrite area R0 (scan electrodes not corresponding to the rewrite area R0; skip area) S11 and S13 at a high speed to maintain the original image as it is.

Thus, the scan operation performed by the scan driver 121 first scans the non-partial rewrite area S11 at high speed, and upon reaching the partial rewrite area R0, scans the area R0 at an ordinary speed to rewrite an image, and upon completion of scanning of the rewrite area R0, scans the non-partial rewrite area S13 at high speed. In this way, processing operation of partial rewriting of an image can be accomplished at high speed.

Here, in the skip area (S11, S13) where rewriting is not performed, most preferably the voltage output from the data driver 122 is turned off so as not to influence the existing display image. Since response of liquid crystal falls off at high speed, this can be utilized to perform scanning and obtain the same effect without turning off the output voltage.

FIG. 5 is a view useful for explaining the shift of threshold characteristics due to high speed scanning.

Thus, in the high speed mode of scanning the areas (S11, S13) before and after the rewrite area R0, a voltage of, for example, ±24V or ±32V, is applied. However, since the threshold characteristics at high speed shifts greatly (to high voltage side), specifically the operating threshold voltage of cholesteric liquid crystal shifts to a voltage of 32V or higher, so that orientation state (display state) of the liquid crystal is not changed by the application of voltage of, for example, ±24V or ±32V. Therefore, in the skip areas S11 and S13, original image can be maintained simply by scanning at high speed without turning off the voltage output.

Thus, in accordance with the related art of drive method for driving a display element, when a portion of original image is to be partially rewritten, it is possible to speed-up the rewrite processing.

However, with the related art of drive method for driving a display element, there is a problem to be solved as disclosed below.

FIG. 6A is a view useful for explaining the problem in the related art of drive method for driving a display element.

As shown in FIG. 6A, if, for example, the rewrite area R1 has a long shape extending in the scanning direction (vertical direction in FIG. 6A), the area S22 including the rewrite area R1 to be scanned at an ordinary speed comprises almost entire area, and the skip areas S21, S23 not to be rewritten and to be scanned at high speed comprise only a small portion, so that full effect of speed-up cannot be exploited.

Thus, when the rewrite area R1 covers almost all the area of the scan side as shown in FIG. 6A, in the method of driving the display element according to above-mentioned related art, although rewriting is only partial, most portion of the screen is scanned, and advantage of time reduction of partial rewriting cannot be fully exploited.

### SUMMARY

According to an aspect of an embodiment, there is provided a method of driving a display element including a plurality of first electrodes and a plurality of second electrodes intersecting each other in mutually opposing state, and a display medium between each of the first electrodes and each of the second electrodes, the display element being driven by a first driver coupled to the first electrodes and a second driver coupled to the second electrodes, wherein one of the first and second drivers is used as a scan driver and the other of the first and second drivers is used as a data driver; and in a partial rewrite area in an existing display image, the driver with smaller number of electrodes corresponding to the rewrite area is selected as the scan driver.

### BRIEF DESCRIPTION OF THE DRAWINGS

FIG. 1A is a view (1) useful for explaining an orientation state of cholesteric liquid crystal;

FIG. 1B is a view (2) useful for explaining an orientation state of cholesteric liquid crystal;

FIG. 2A is a view (1) showing a voltage characteristics for driving cholesteric liquid crystal;

FIG. 2B is a view (2) showing a voltage characteristics for driving cholesteric liquid crystal;

FIG. 2C is a view (3) showing a voltage characteristics for driving cholesteric liquid crystal;

FIG. 3 is a view showing reflectivity characteristics of cholesteric liquid crystal;

FIG. 4A is a view (1) useful for explaining an example of drive method for driving a display element according to a related art;

FIG. 4B is a view (2) useful for explaining an example of drive method for driving a display element according to the related art;

FIG. 5 is a view useful for explaining the shift of threshold characteristics due to high speed scanning;

FIG. 6A is a view useful for explaining a problem of the drive method for driving a display element according to the related art;

FIG. 6B is a view useful for explaining the principle of the drive method for driving a display element according to the embodiment;

FIG. 7 is a block diagram schematically showing a display device according to a first example of the embodiment;

FIG. 8 is a sectional view schematically showing an example of display element in the display device shown in FIG. 7;

FIG. 9A is a view (1) useful for explaining an example of the drive method for driving a display element according to the embodiment;

FIG. 9B is a view (2) useful for explaining an example of the drive method for driving a display element according to the embodiment;

FIG. 9C is a view (3) useful for explaining an example of the drive method for driving a display element according to the embodiment;

FIG. 9D is a view (4) useful for explaining an example of the drive method for driving a display element according to the embodiment;

FIG. 10A is a flow chart (1) useful for explaining an example of the drive method for driving a display element according to the embodiment;

FIG. 10B is a flow chart (2) useful for explaining an example of the drive method for driving a display element according to the embodiment;

FIG. 11 is a view schematically showing essential part of a display device according to a second example of the embodiment;

FIG. 12 is a view useful for explaining switching of the driver in the display device shown in FIG. 11;

FIG. 13 is a view schematically showing essential part of a display device according to a third example of the embodiment;

FIG. 14 is a view useful for explaining switching of the driver in the display device shown in FIG. 13;

FIG. 15A is a view showing an example of input voltage to the driver in the scan mode and the data mode;

FIG. 15B is a view showing an example of correspondence in the case of driving cholesteric liquid crystal;

FIG. 15C is a view showing an example of output voltage of the driver in the scan mode and the data mode;

FIG. 15D is a view showing an example of synthetic waveform applied to the liquid crystal;

FIG. 16A is a view showing another example of input voltage to the drivers in the scan mode and the data mode;

FIG. 16B is a view showing another example of correspondence in the case of driving cholesteric liquid crystal;

FIG. 16C is a view showing another example of output voltage to the drivers in the scan mode and the data mode; and

FIG. 16D is a view showing another example of synthetic waveform applied to the liquid crystal.

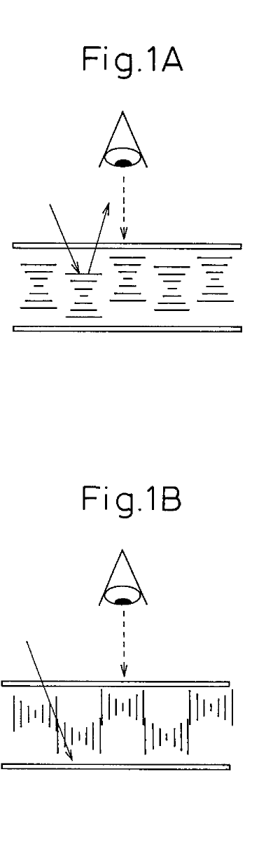

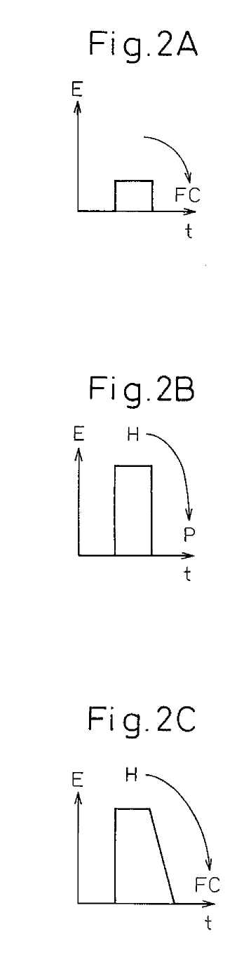

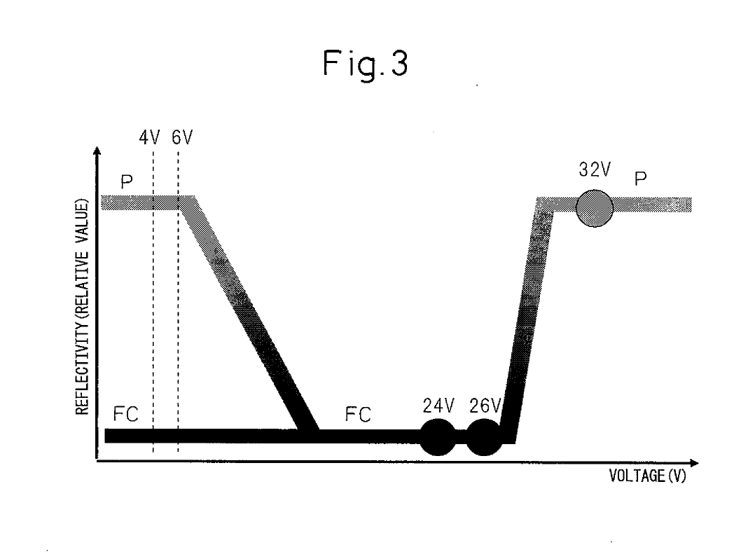

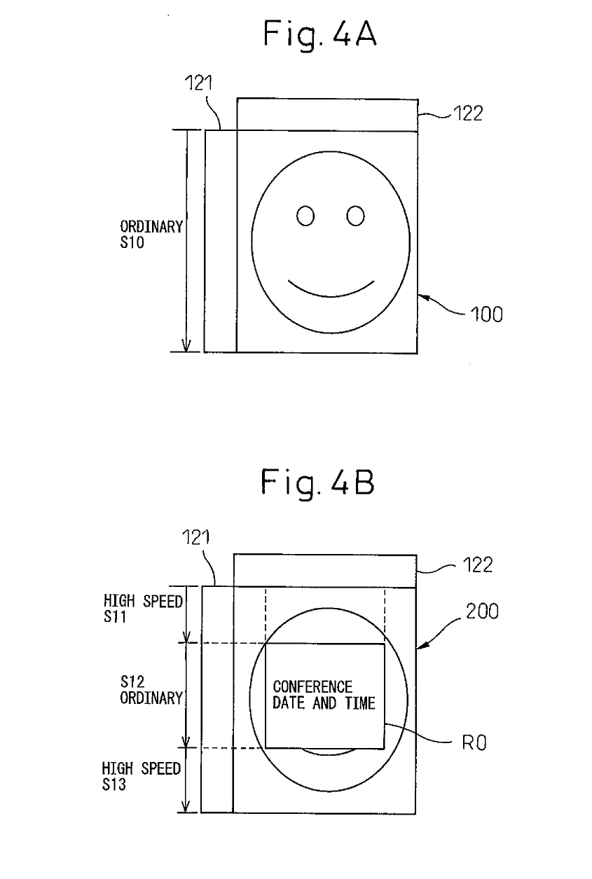

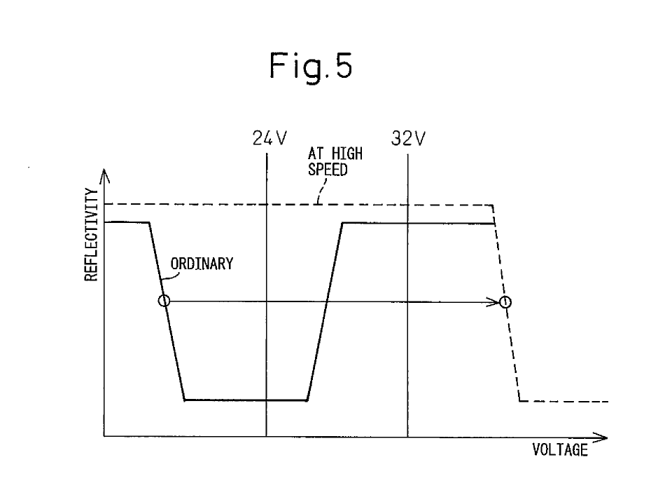

### DETAILED DESCRIPTION OF THE EMBODIMENTS

First, the principle of the drive method for driving a display element according to the embodiment will be disclosed.

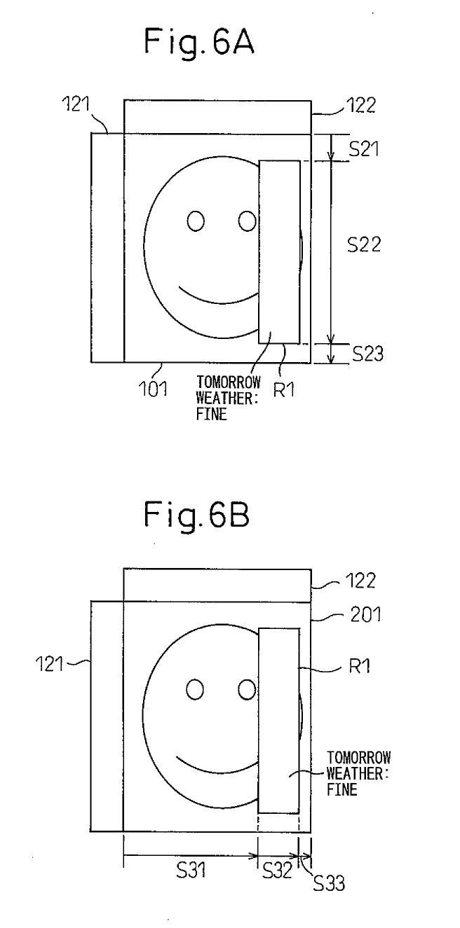

FIG. 6B is a view useful for explaining the principle of the drive method for driving a display element according to the embodiment.

As is evident from the comparison of FIG. 6A and FIG. 6B, in the drive method for driving a display element according to the embodiment, when the rewrite area R1 has a shape that is longer in vertical direction in the image, the driver which has smaller number of electrodes corresponding to the rewrite area is selected as the scan driver.

Thus, as shown in FIG. 6B, if the rewrite area R1 has a shape that is longer in vertical direction, the scan direction is switched to horizontal direction. Therefore, in FIG. 6B, the driver 121 for vertical direction is used as the data driver, and the driver 122 for horizontal direction is used as the scan driver. Here, in order to switch from the case where the driver 122 for horizontal direction is used as the data driver to the case where the driver 121 for vertical direction is used as the data driver, the image data to be supplied to the data driver need to be converted, and this conversion is performed by the driver selection and data conversion circuit (44).

Then, as shown in FIG. 6B, when, for example, the rewrite area R1 has a shape that is longer in the scan direction ‘vertical direction), scanning is performed at an ordinary speed only in the area S32 corresponding to the shorter side of the rewrite area R1, and high speed scanning is performed in other areas S31 and S33, that is, in almost the entire areas. Effect of high speed processing can be thereby fully made use of.

### Embodiments

Now, a drive method for driving display element and a display device according to embodiments of the embodiment will be disclosed in detail with reference to appended drawings.

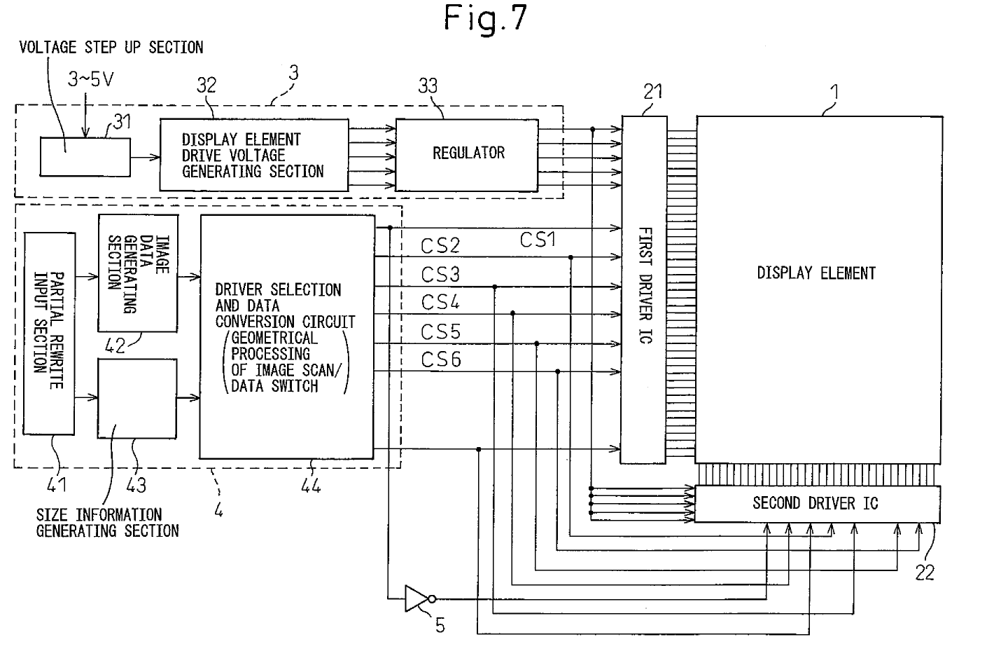

FIG. 7 is a block diagram schematically showing a display device (electronic terminal) according to a first example of the embodiment. In FIG. 7, reference numeral 1 denotes a display element, 3 denotes a power supply circuit, 4 denotes a control circuit, 5 denotes an inverter, 21 denotes a first driver IC (first driver), and 22 denotes a second driver IC (second driver).

As shown in FIG. 7, the power supply circuit 3 comprises a voltage step-up section 31, a drive voltage generating section for display element (voltage generating section) 32 and a regulator 33. The voltage step-up section 31 receives an input voltage of about +3 to +5V from a battery, and raises it to a step-up voltage for driving a display medium (display element 1) and supply the step-up voltage to the voltage generating section 32. The voltage generating section 32 generates required voltage for the first driver 21 and the second driver 22, respectively. The regulator 33 stabilizes the voltage from the voltage generating section 32 and supplies it to the first driver 21 and the second driver 22.

The control circuit 4 comprises a partial rewrite input section 41, an image data generating section 42, a size information generating section 43, and a driver selection and data conversion circuit 44. The control circuit 4 performs operation on the image data supplied from outside and control signal, sets one of the first driver 21 and the second driver 22 as the scan driver or the data driver, and sets the other as the data driver or the scan driver, and supplies suitable signal to the set scan driver 21 (22) and to the set data driver 22 (21).

The partial rewrite input section 41 recognizes the partial rewrite from the image data supplied from outside and control signal, and the image data generating section 42 generates the image data for the area of partial rewrite, and the size information generating section 43 generates size information of the area of partial rewrite (position information in the image screen of the rewrite area). These image data and size information of the rewrite area are inputted to the driver selection and data conversion circuit 44, and the driver selection and data conversion circuit 44 outputs scan/data mode signal CS1, data capture clock CS2, pulse polarity control signal CS3, frame start signal CS4, data latch/scan shift signal CS5, and driver output shutoff signal CS6.

Here, the data capture clock CS2 is the signal which is supplied to the driver set to data mode for successively capturing data for one line (in the case of partial rewrite, data for the rewrite area), and the pulse polarity control signal CS3 is the signal for inversion control of the polarity of pulse voltage given to the display element 1, and the frame start signal CS4 is the signal indicating the start of an image for one frame, and the data latch/scan shift signal CS5 is the signal for synchronous control of the line to which data are stored by the data driver and the line which is selected by the scan driver, and the driver output shutoff signal is the signal for shutting off the driver output of the data driver or the scan driver.

The scan/data mode signal CS1 is the signal indicating which of the first driver 21 and the second driver 22 is set as the scan driver, and this scan/data mode signal CS1 is adapted to be directly inputted to the first driver 21 and to be inputted via the inverter 5 to the second driver 22. With this construction, one of the first driver 21 and the second driver 22 is set as the scan driver (in scan mode) and the other of the first driver 21 and the second driver 22 is set as the data driver (in data mode).

Thus, when a portion of the area in an existing display image is to be rewritten, the driver coupled to the smaller number of electrodes corresponding to the rewrite area is selected as the scan driver, and the driver coupled to the larger number of electrodes corresponding to the rewrite area is selected as the data driver. If same number of electrodes corresponds to the rewrite area both in vertical direction and horizontal direction, that is, the rewrite area is of a square shape, the scan driver and the data driver are set, for example, in the same selection as in writing of the existing display image.

Therefore, selection of the scan mode and the data mode of the drivers is done such that, in the display element shown in FIG. 7, when a horizontally oblong (horizontal image size>vertical image size) partial rewrite pattern (rewrite area) is inputted, the first driver 21 is set in scan mode (scan driver) and the second driver 22 is set in data mode (data driver), and when a vertically oblong (vertical image size>horizontal image size) partial rewrite pattern (rewrite area) is inputted, the first driver 21 is set in data mode (data driver) and the second driver 22 is set in scan mode (scan driver).

The selection (setting) of the scan mode and the data mode is done with the scan/data mode signal CS1 of one bit, for example, such that, when this signal CS1 is in the low level, “L”, the driver is set in scan mode (scan driver), and if this signal CS1 is in the high level, “H”, the driver is set in data mode (data driver). Setting of the first and the second drivers may be done by applying, other than the above-disclosed method, conventionally known various other methods.

When switching between the case where the vertical first driver 21 is used as the scan driver and the horizontal second driver 22 is used as data driver and the case where the vertical first driver 21 is used as the data driver and the horizontal second driver 22 is used as scan driver, the image data supplied to the respective data drivers 22 and 21 need to be converted. This conversion of image data is done by the driver selection and data conversion circuit 44. Thus, the driver selection and data conversion circuit 44 not only receives output of the image data generating section 42 and the size information generating section 43 and decides the function of scan mode/data mode of each driver, but also rearranges (converts) the image data to be inputted to each driver as required.

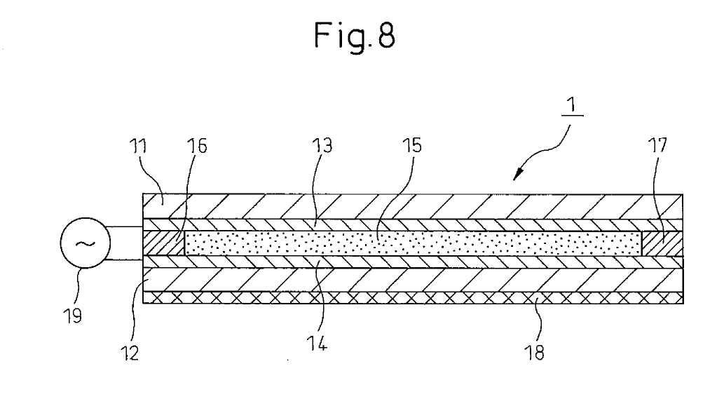

FIG. 8 is a sectional view schematically showing an example of display element (liquid crystal element) in the display device shown in FIG. 7. In FIG. 8, reference numerals 11 and 12 denote film substrates, 13 and 14 denote transparent electrodes (for example, ITO electrodes), 15 denotes a liquid crystal composition (cholesteric liquid crystal), 16 and 17 denote sealants, 18 denotes a light absorption layer, and 19 denotes a driver circuit.

The display element 1 contains liquid crystal composition 15, and on the inner surfaces (surfaces with the liquid crystal composition 15 sealed therebetween) of the transparent film substrates 11 and 12, there are formed orthogonally intersecting transparent electrodes 13 and 14, respectively. Thus, on the opposing film substrates 11 and 12, a plurality of scan electrodes 13 and a plurality of data electrodes 14 are formed in the shape of matrix. In FIG. 8, the scan electrodes 13 and the data electrodes 14 are depicted seemingly parallel to each other. However it is to be understood that, in practice, a plurality of data electrodes 14 intersect one scan electrode 13, for example. Thickness of each of the film substrate 11 and 12 is, for example, about 0.2 mm. and thickness of the liquid crystal composition layer 15 is, for example, in the range of 3 μm to 6 μm. However, for the sake of simplicity of explanation, these are depicted out of proportion in the Figure.

Preferably, an insulating thin film or an orientation stabilizing film is coated on each of the electrodes 13 and 14. A visible-light absorption layer 18 may be provided, as required, on the outer surface (back surface) of the substrate (12) on the side opposite to the side of incident light.

In this embodiment, the liquid crystal composition 15 is cholesteric liquid crystal that exhibits cholesteric phase at room temperature. Materials and their combination will be specifically disclosed below with reference to an experimental example.

The sealant 16 and 17 are for sealing the liquid crystal composition 15 between the film substrates 11 and 12. The drive circuit 19 is for applying specified pulse voltage to the electrodes 13 and 14.

The film substrates 11 and 12 are both translucent. In order to be able to use a pair of substrates as a display element of the present example, it is necessary that at least one of the substrates is translucent. Examples of translucent substrate include glass substrates. Other than glass substrates, flexible resin film substrates such as PET and PC may be used. As electrodes 13 and 14, ITO (Indium Tin Oxide), for example, is representative. Other than ITO, transparent conductive film such as IZO (Indium Zinc Oxide), or metal electrode such as aluminium or silicon or amorphous silicon, or photoconductive film such as BSO (Bismuth Silicon Oxide) may be used.

In the liquid crystal display element shown in FIG. 8, as has been disclosed, a plurality of mutually parallel strip-shaped transparent electrodes 13 and 14 are formed on the inner surfaces of the transparent film substrates 11 and 12, and these electrodes 13 and 14 are opposed to each other so as to intersect each other as viewed from the direction perpendicular to the substrates.

The display element according to the embodiment may have an insulating thin film formed thereon with function of preventing short-circuiting between electrodes or serving as gas barrier layer to improve reliability of the liquid crystal display element. As orientation stabilizing film, organic film such as polyimide resin, polyamide-imide resin, polyether-imide resin, polyvinyl-butylal resin, acrylic resin; or inorganic material such as silicon oxide, aluminium oxide, may be used. The orientation stabilizing film coated on the electrodes 13 and 14 may also be used as an insulating thin film.

The liquid crystal display element according to the embodiment may have spacers provided between a pair of substrates for maintaining uniform gap between substrates. As spacers, spheres formed of resin or of inorganic oxides can be used, for example. Adhesive spacers having thermoplastic resin coated on the surface thereof may be advantageously used

Material for constituting the liquid crystal composition (liquid crystal layer) 15 is, for example, cholesteric liquid crystal formed from nematic liquid crystal composition by adding 10 to 40 wt % of chiral agent. Amount of added chiral agent is expressed as a percentage with the sum of the nematic liquid crystal component and the chiral agent as 100 wt %.

Various conventionally known nematic liquid crystal can be used. In view of drive voltage, nematic liquid crystal having dielectric anisotropy of 20 or more is preferred. If the nematic liquid crystal having dielectric anisotropy of 20 or more, drive voltage becomes relatively low. Dielectric anisotropy (Δε) of 20 to 50 is preferable as cholesteric liquid crystal. If dielectric anisotropy is roughly in this range, a general purpose driver can be used.

Anisotropy of refractive index (Δn) is preferably in the range of 0.18 to 0.24. If the anisotropy of refractive index is below this range, reflectivity in the planar state becomes too small, and if the anisotropy of refractive index is above this range, scattering reflection in focal conic state becomes too large, and viscosity becomes high and response speed is lowered. Thickness of the liquid crystal is preferably in the range of 3 μm to 6 μm. If thickness is below this range, reflectivity in planar state becomes too small, and if thickness is above this range, drive voltage becomes undesirably high.

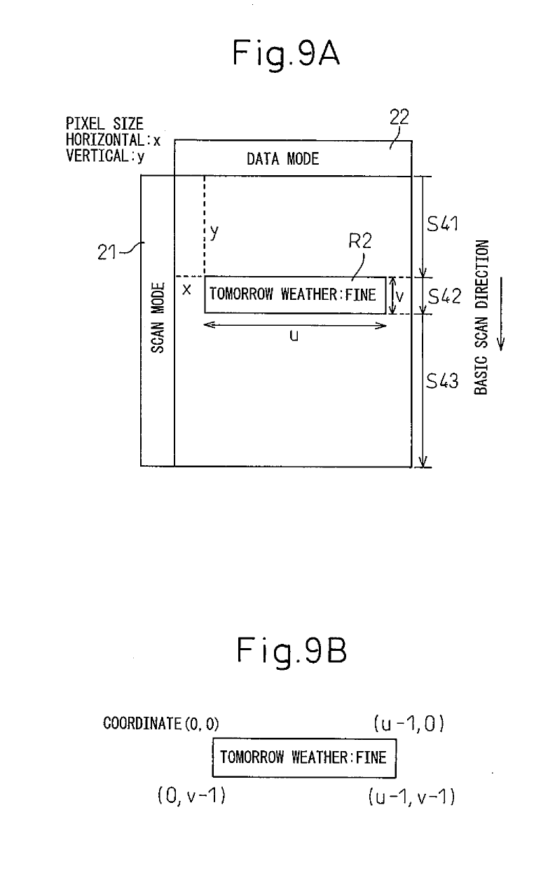

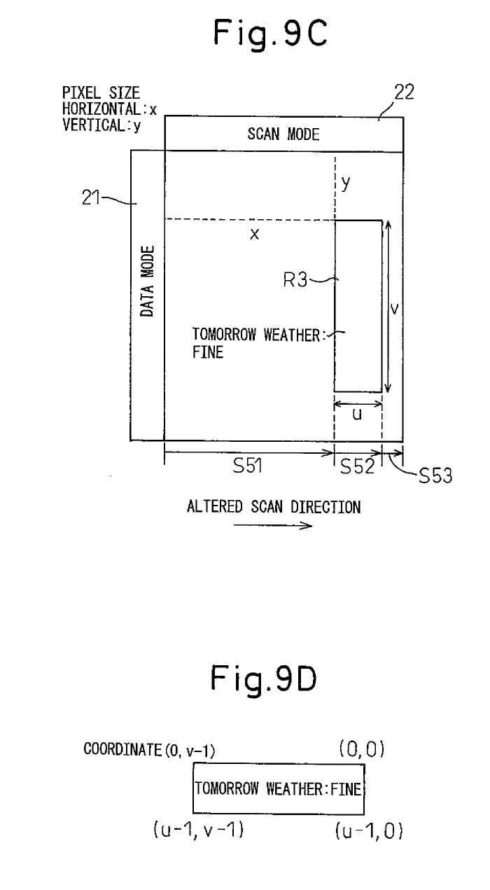

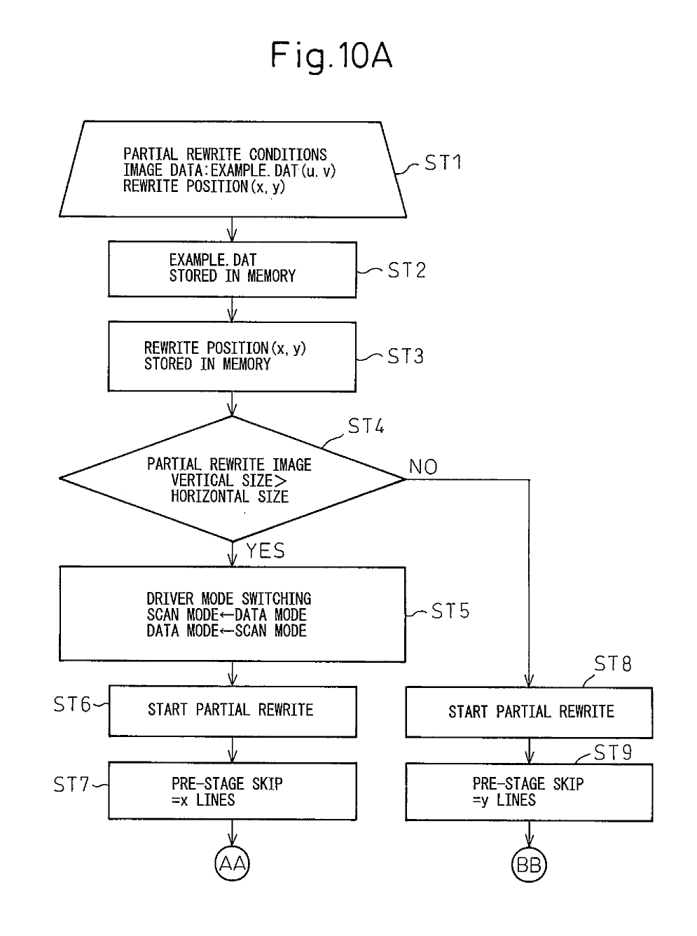

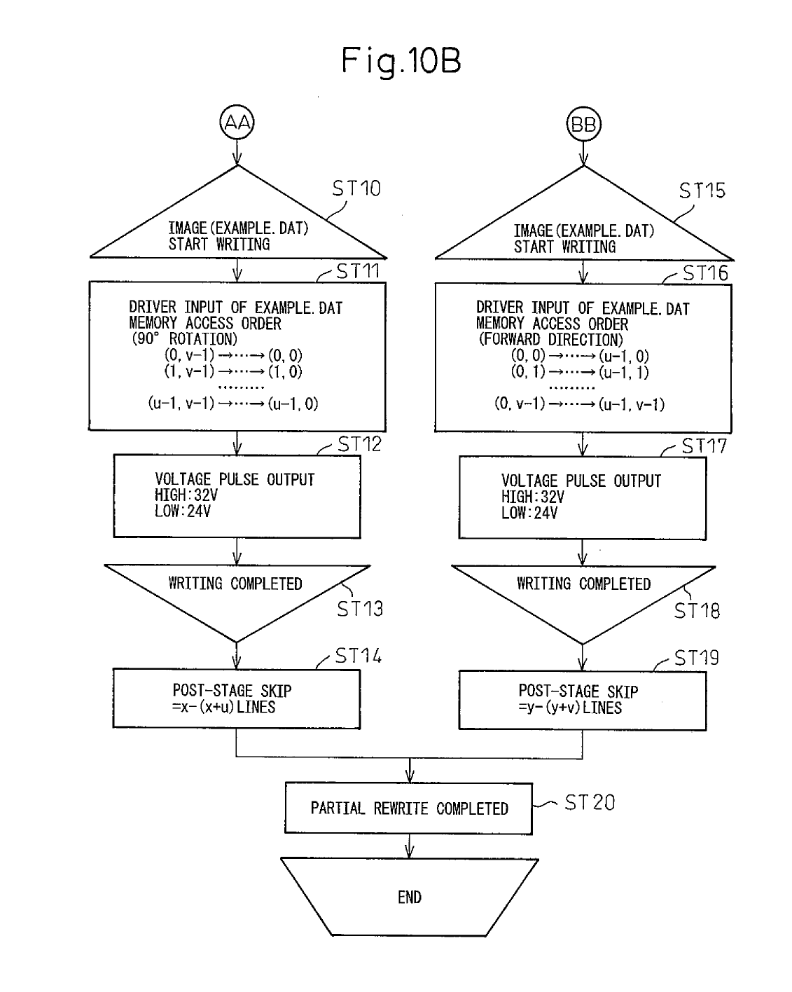

FIG. 9A to FIG. 9D are views useful for explaining an example of drive method for driving the display element according to the embodiment, and FIG. 10A and FIG. 10B are flow charts useful for explaining an example of drive method for driving the display element according to the embodiment. Here, FIG. 9A and FIG. 9B show the case where the partial rewrite image pattern is horizontally oblong, and FIG. 9C and FIG. 9D show the case where the partial rewrite image pattern is vertically oblong.

First, at operation ST1, partial rewrite conditions, that is, image data Example.dat(u, v), and rewrite position (x, y), are set. Then, proceeding to operation ST2, the image data Example.dat(u, v) are stored in memory, and proceeding to operation ST3, the rewrite position (x, y) is stored in memory. Then, proceeding to operation ST4, with respect to size of the partial rewrite image, it is determined whether or not vertical size>horizontal size.

At operation ST4, if it is determined that the vertical size of the partial rewrite image (R2) is not greater than the horizontal size (vertical size≦horizontal size), that is, in the partial rewrite area in the display image, the number of first electrodes in vertical direction corresponding to the rewrite area R2 is smaller than the number of second electrodes in horizontal direction, the flow proceeds to operation STS, and rewriting is started. This state corresponds to FIG. 9A and FIG. 9B, and the first driver 21 is set in scan mode (scan driver) and the second driver 22 is set in data mode (data driver). The scan direction in this case where the first driver 21 is the scan driver and the second driver 22 is the data driver (from top to bottom in FIG. 9A) is set as basic scan direction in advance.

Next, the flow proceeds to operation ST9, where y line (area S41) is skipped (high speed scanning), and then, the flow proceeds to operation ST 15, where writing of image corresponding to the rewrite area R2 is started from the area S42. Thus, at operation ST16, as shown in FIG. 9A and FIG. 9B, data are successively supplied to the driver in data mode (second driver) 22 by associating the coordinate of image data in the rewrite area R2 with the corresponding scan line in the area S42.

Thus, when the image in the rewrite area R2 is a horizontally oblong character string, “TOMORROW WEATHER: FINE”, vertical scan direction (basic scan direction) is selected, and to the driver 22 currently set in data mode, the coordinate data of each line of the partial rewrite image stored in the memory, (0, 0), (1, 0), (2, 0), . . . , (u−1, 0); (0,1), (1, 1), (2, 1), . . . , (u−1, 1); . . . ; (0, v−1), (1, v−1), (2, v−1), . . . , (u−1, v−1), are successively written in the data driver 22 in correspondence to each scan line of the area S42.

Then, the flow proceeds to operation ST17, where voltage pulse output (32V or 24V) is given to corresponding data electrode (second electrode), and the flow proceeds to operation ST18, where writing of the rewrite area R2 is terminated. Then, the flow proceeds to operation ST19, where Y−(y+v) lines (area S43) are scanned in high speed, and then, the flow proceeds to operation ST20, where the partial rewrite is completed.

On the other hand, if, at operation ST4, it is determined that the vertical size of the partial rewrite image (R2) is larger than the horizontal size (vertical size>horizontal size), that is, in the partial rewrite area in the display image, the number of first electrodes in vertical direction corresponding to the rewrite area R2 is larger than the number of second electrodes in horizontal direction, the flow proceeds to operation ST5, where the driver modes are switched. That is, the scan mode is switched to data mode, and the data mode is switched to scan mode. This state corresponds to FIG. 9C and FIG. 9D, and the first driver 21 is set in data mode (data driver) and the second driver 22 is set in scan mode (scan driver).

Next, the flow proceeds to operation ST6, where partial rewriting is started, and then to operation ST7, where x line (area S51) is skipped (high speed scanning), and then, the flow proceeds to operation ST 10, where writing of image corresponding to the rewrite area R3 is started from the area S52. Thus, at operation ST11, as shown in FIG. 9C and FIG. 9D, data are successively supplied to the driver in data mode (first driver) 21 by associating the coordinate of image data in the rewrite area R3 with the corresponding scan line in the area S52.

Thus, when the image in the rewrite area R3 is a vertically oblong character string, “TOMORROW WEATHER: FINE”, horizontal scan direction (altered scan direction) is selected, and to the driver 21 currently set in data mode, the coordinate data of each line of the partial rewrite image stored in the memory, (0, v-1), (0, v-2), (0, v-3), . . . , (0, 0); (1, v-1), (1, v-2), (1, v-3), . . . , (1, 0); . . . ; (u-1, v-1), (u-1, v-2), (u-1, v-3), . . . , (u-1, 0), are successively written in the data driver 21 in correspondence to each scan line of the area S52.

Then, the flow proceeds to operation ST12, where voltage pulse output (32V or 24V) is given to corresponding data electrode (first electrode), and the flow proceeds to operation ST13, where writing of the rewrite area R3 is terminated. Then, the flow proceeds to operation ST14, where X-(x+u) lines (area S53) are scanned in high speed, and then, the flow proceeds to operation ST20, where the partial rewrite is completed.

In this way, in accordance with switching of scan mode/data mode, the procedure of access to the address of the image pattern to be partially rewritten is altered.

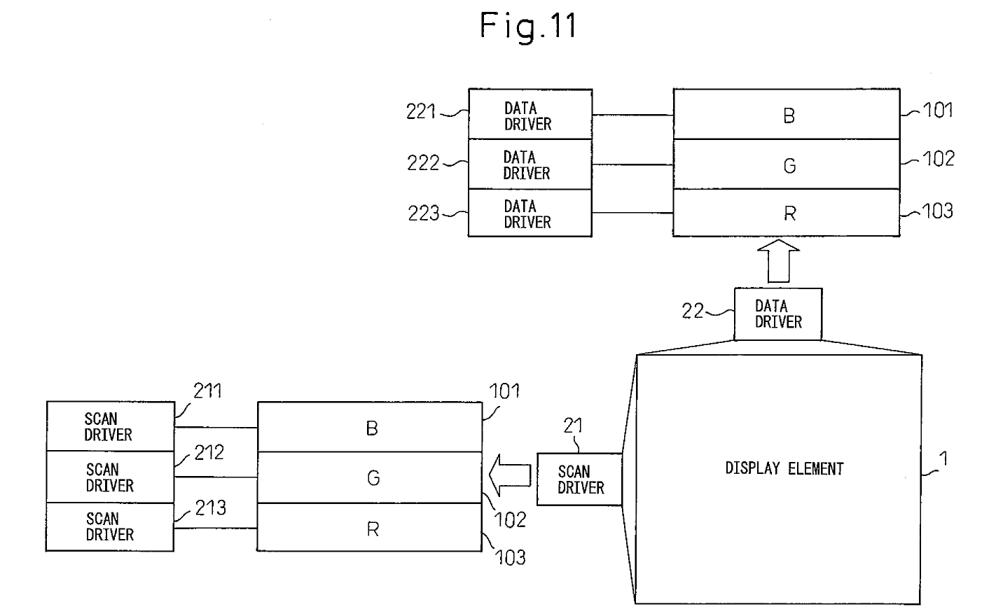

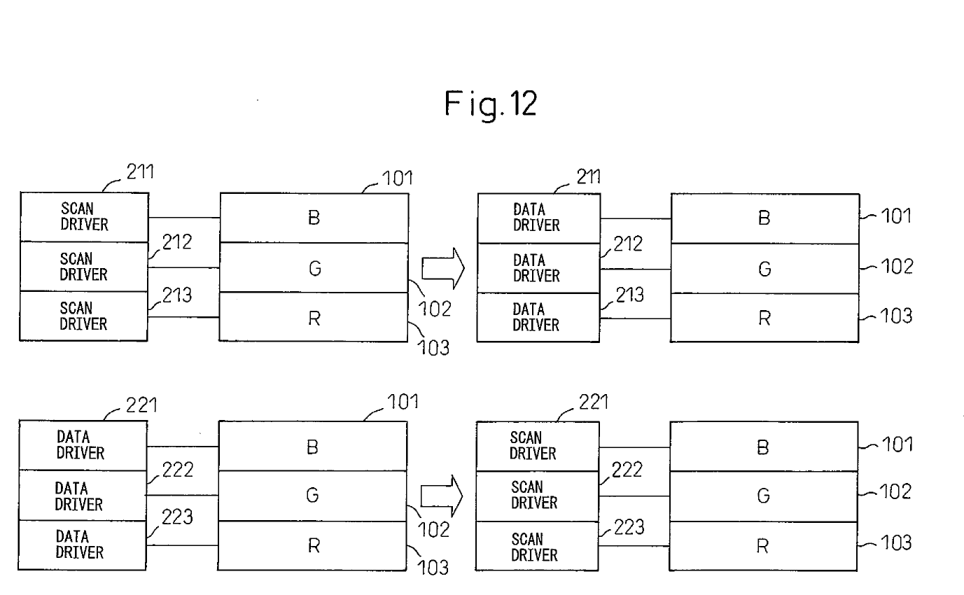

FIG. 11 is a view schematically showing essential part of a display device according to a second example of the embodiment, and FIG. 12 is a view useful for explaining switching of the driver in the display device shown in FIG. 11. In FIG. 11 and FIG. 12, reference numeral 101 denotes the blue (B) layer for reflecting blue light, 102 denotes the green (G) layer for reflecting green light, and 103 denotes the red (R) layer for reflecting red light. A black (K) layer for absorbing light can also be provided under R layer 103.

As shown in FIG. 11, a display device according to the second example has scan drivers (first drivers) 211, 212 and 213 and data drivers (second drivers) 221, 222 and 223 provided for B layer 101, G layer 102 and R layer 103, respectively. In each layer 101, 102 and 103, scan electrodes and data electrodes coupled to the scan drivers 211, 212 and 213 and data drivers 221, 222 and 223, respectively, and in opposition to and intersecting each other with cholesteric liquid crystal (display medium) sandwiched therebetween, enable the display element 1 to display in nearly full color.

As shown in FIG. 12, when, for example, rewriting is to be performed in a vertically oblong rewrite area R3 as shown in FIG. 9C, all the drivers in B layer 101, G layer 102 and R layer 103 are switched between scan mode and data mode. That is, the first drivers 211, 212 and 213 of B layer 101, G layer 102 and R layer 103 in scan mode (scan drivers) are switched to data mode (data drivers), and the second drivers 221, 222 and 223 of B layer 101, G layer 102 and R layer 103 in data mode (data drivers) are switched to scan mode (scan drivers). With this, partial rewriting can be performed in color satisfying color numbers.

When partial rewriting is to be performed only in green color (G), the mode switching of drivers and rewriting operations are performed only in G layer 102 in accordance with the image pattern, with no operation performed in B layer 101 and R layer 103.

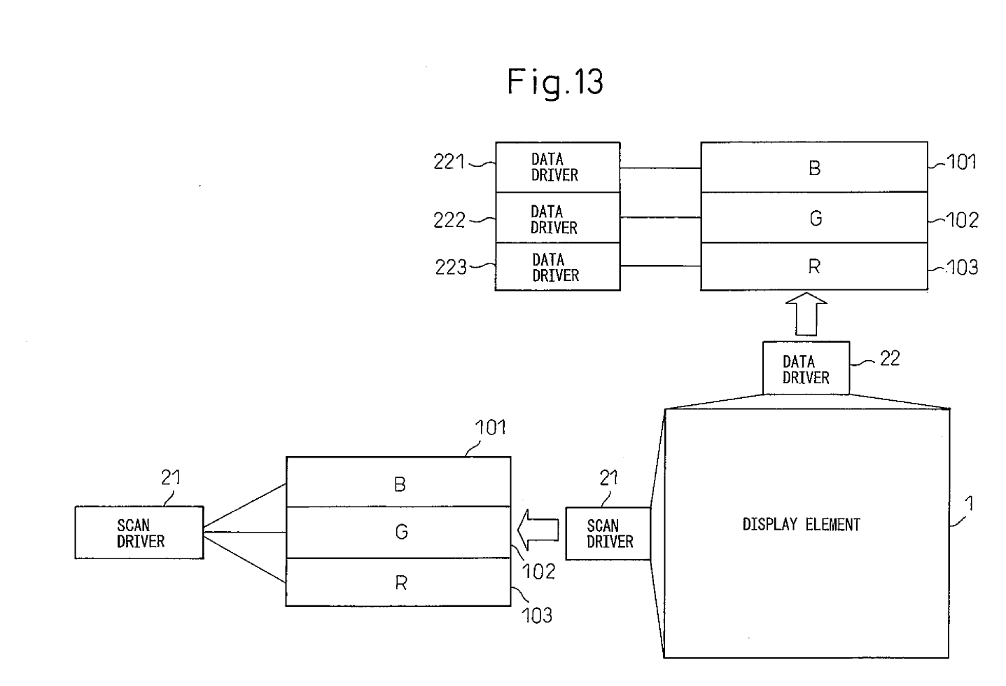

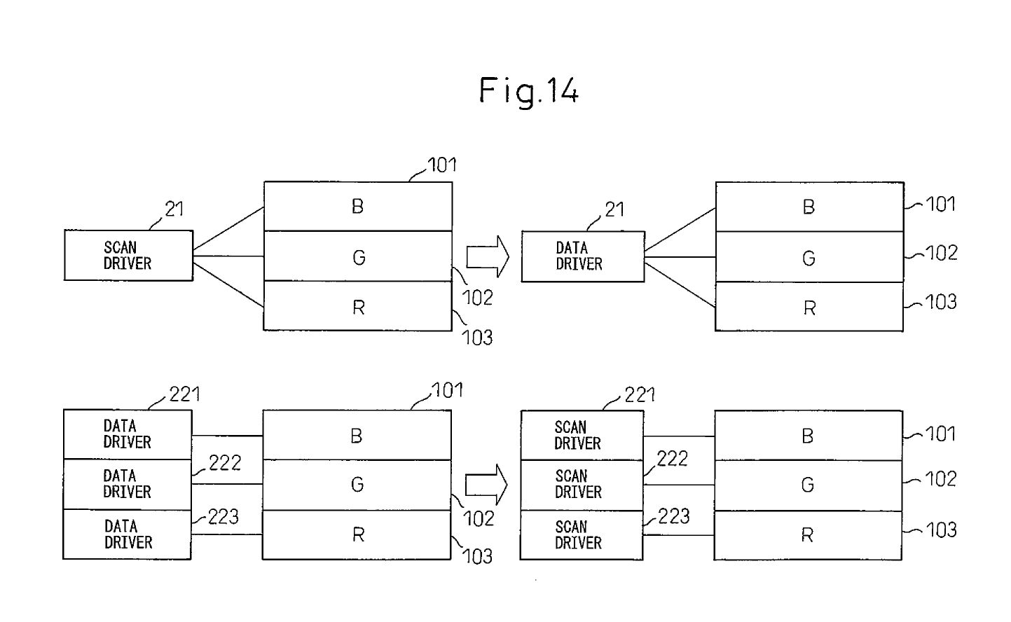

FIG. 13 is a view schematically showing an essential part of a display device according to a third example of the embodiment, and FIG. 14 is a view useful for explaining switching of drivers in the display device shown in FIG. 13.

As shown in FIG. 13, the display device according to the third example comprises a common scan driver (first driver) 21 and individual data drivers (second driver) 221, 222 and 223 for B layer 101, G layer 102 and R layer 103.

As shown in FIG. 14, when, for example, rewriting is to be performed in vertically oblong rewrite area R3 as shown in FIG. 9C, the driver 21 in the scan mode common to B layer 101, G layer 102 and R layer 103 is switched to data mode, and the second driver 221, 222 and 223 in data mode for B layer 101, G layer 102 and R layer 103 are switched to scan mode. In this case, since the data driver 21 is common to B layer 101, G layer 102 and R layer 103, the image for partial rewrite is a black-and-white display, for example.

In this way, when, for example, the image for partial rewrite is a black-and-white display, and high speed rewriting is desired, one of the drivers (for example, first driver) used as the scan driver in ordinary writing, may be constructed as a common driver common to B layer 101, G layer 102 and R layer 103, to thereby reduce the number of drivers, etc., and to reduce the cost.

In partial rewrite, if the shape of the rewrite area has a horizontally oblong display pattern, since switching of drivers between scan mode and data mode is not required, partial rewrite in color is possible.

Thus, when one of the drivers is common to B layer 101, G layer 102 and R layer 103, the number of colors that can be displayed may be limited. However, this may be sufficient when the partial rewrite is performed in characters or number patterns such as a memorandum or a time display, which needs not be displayed in color. In this case, it is also possible to selectively control whether or not function switching of drivers should be performed in dependence on whether the pattern for partial rewrite is characters or an image.

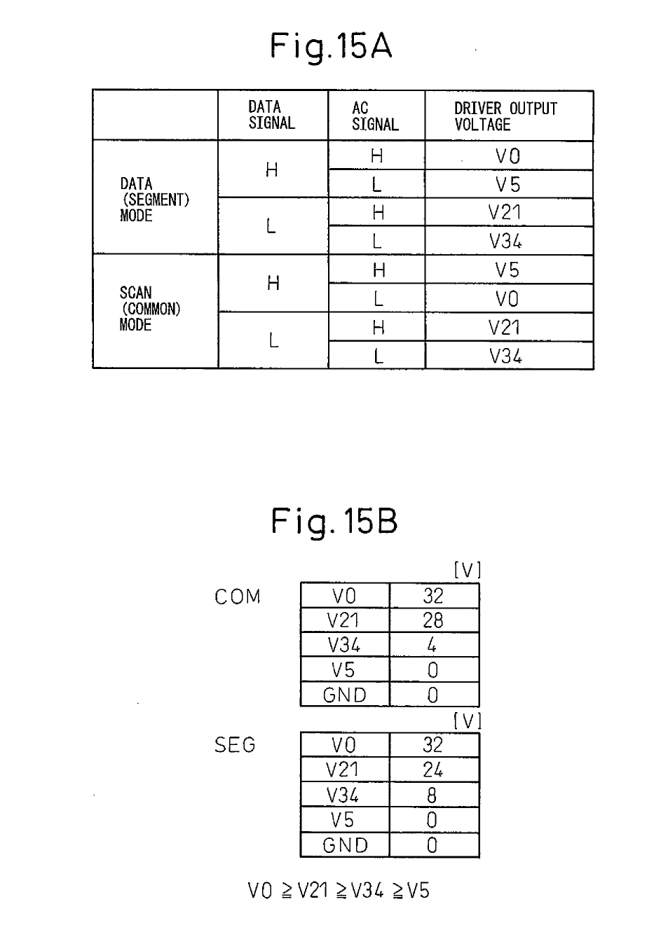

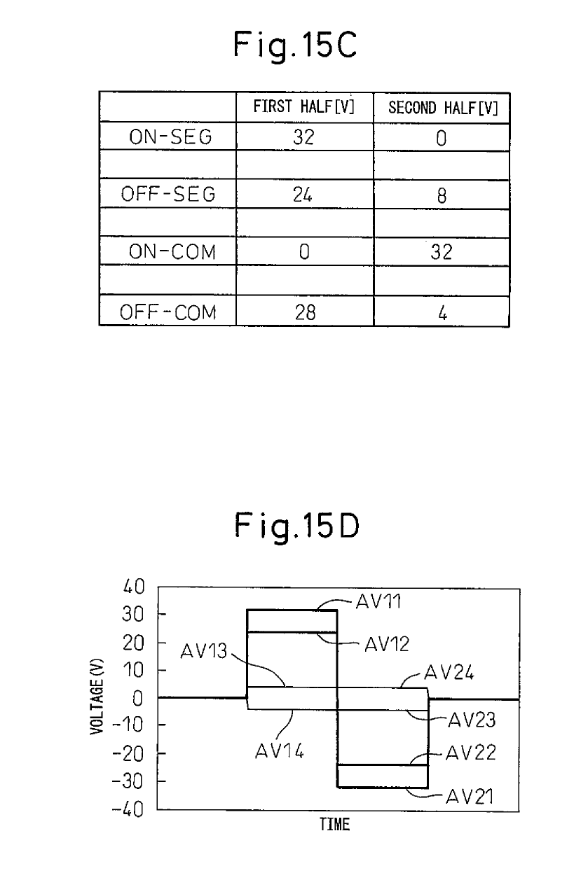

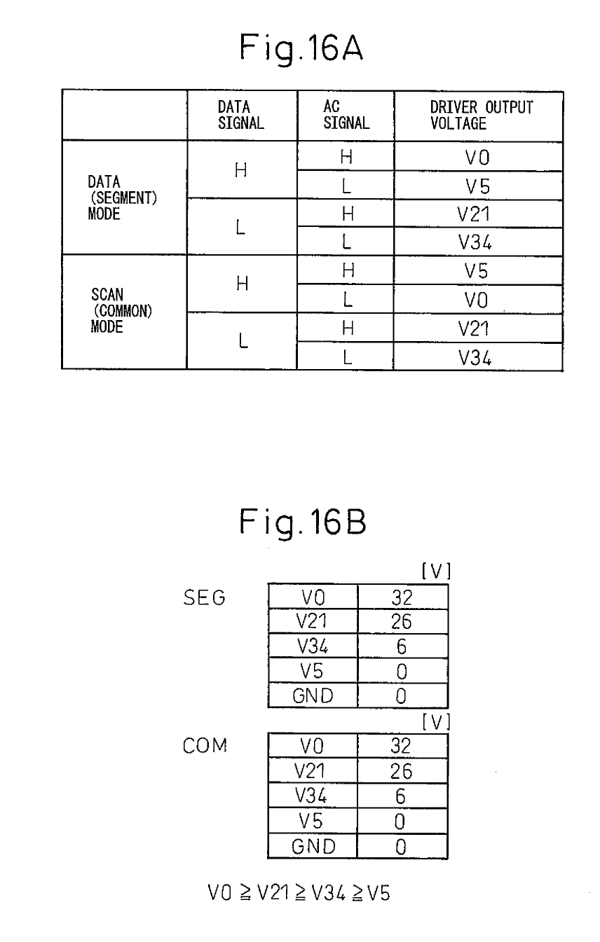

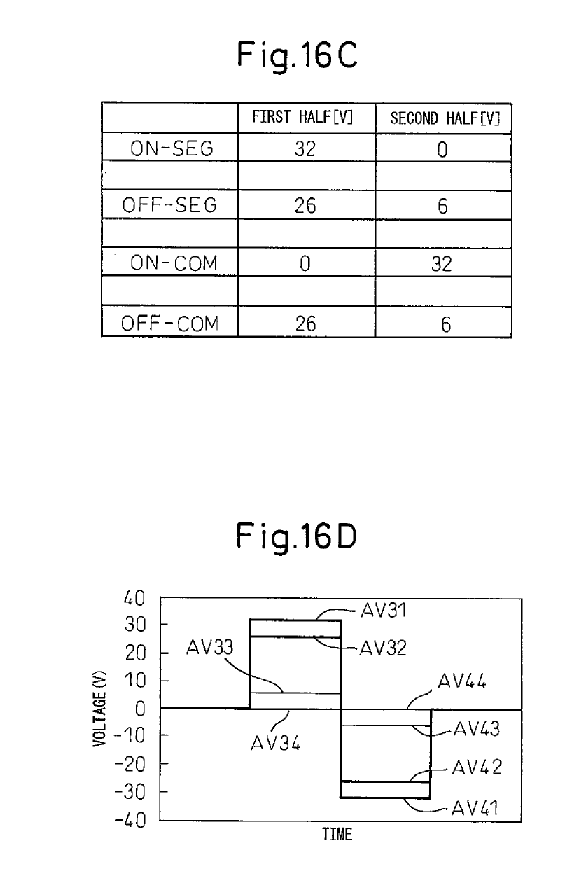

Next, the driving voltage of the color display element for QVGA prepared by applying the display device of the second example shown in FIG. 11 and FIG. 12 as disclosed above, will be disclosed with reference to FIG. 15A to 15D, and FIG. 16A to FIG. 16D. General purpose STN drivers are used as the first drivers 211 to 213, and the second drivers 221 to 223. Also, an OP amp voltage follower can be applied to stabilize the voltage input to each driver.

FIG. 15A is a view showing an example of input voltage to a driver in scan mode and data mode, FIG. 15B is a view showing an example of correspondence in the case of driving cholesteric liquid crystal, FIG. 15C is a view showing an example of output voltage of a driver in the scan mode and the data mode, and FIG. 15D is a view showing an example of synthetic waveform applied to the liquid crystal.

As shown in FIG. 15A and FIG. 15B, in data mode (segment mode; data driver), an arbitrary line can be selected. For data signal of high level “H”, a voltage V0 (32V) as high level “H” AC signal, and a voltage V5 (0V) as low level “L” AC signal are used, and for data signal of low level “L”, a voltage V21 (28V) as high level “H” AC signal, and a voltage V34 (4V) as low level “L” AC signal are used.

In scan mode (common mode; scan driver), selection of an arbitrary line is not possible, and all lines are scanned. For data signal of high level “H”, a voltage V5 (0V) as high level “H” AC signal, and a voltage V0 (32V) as low level “L” AC signal are used, and for data signal of low level “L”, a voltage V21 (28V) as high level “H” AC signal, and a voltage V34 (4V) as low level “L” AC signal are used. Here, the relation V0≧V21≧V34≧V5 holds.

In each element of RGB (R layer 103, G layer 102 and B layer 101), pulse voltages of ±32V and ±24V are stably applied to pixels which are on and to pixels which are off, respectively, and pulse voltage of ±4V is applied to non-selected pixels. Thus, as shown in FIG. 15B, for example, voltages of six levels, that is, 32V, 28V, 24V, 8V, 4V, 0V, generated in the power supply circuit 3 shown in FIG. 7 are inputted to scan drivers (common driver; COM) and data driver (segment driver; SEG).

Thus, voltages of 32V, 28V, 4V, 0V are inputted to the driver in scan mode, and voltages of 32V, 24V, 8V, 0V are inputted to the driver in data mode. When the driver is switched between scan mode and data mode, each voltage inputted to the drivers is also switched.

As shown in FIG. 15C, output voltage of the scan driver at ON and OFF is such that ON-COM is 0V in the first half of AC drive and 32V in the second half of AC drive, and OFF-COM is 28V in the first half of AC drive and 4V in the second half of AC drive. Output voltage of the data driver at ON and OFF is such that ON-SEG is 32V in the first half of AC drive and 0V in the second half of AC drive, and OFF-SEG is 24V in the first half of AC drive and 8V in the second half of AC drive.

As shown in FIG. 15D, to the liquid crystal between each scan electrode and each data electrode (pixel), when selection of the liquid crystal is ON, pulse waveform of AC drive with 32V in the first half AV11 and −32V in the second half AV21 is applied, and when selection of the liquid crystal is OFF, pulse waveform of AC drive with 24V in the first half AV12 and −24V in the second half AV22 is applied. When non-selection of the liquid crystal is ON, pulse waveform of AC drive with 4V in the first half AV13 and −4V in the second half AV23 is applied, and when non-selection of the liquid crystal is OFF, pulse waveform of AC drive with −4V in the first half AV14 and 4V in the second half AV24 is applied.

Partial rewrite area is scanned, for example, at speed of about 10 msec./line, and non-target area where partial rewrite is not performed is scanned, for example, at speed of about μsec./line, so that scanning is accomplished in a moment. It is desirable to turn off the voltage output when non-target area is scanned, but as long as the voltage is below the threshold voltage the liquid crystal (pixel) can respond at high speed scanning, there is no problem even if the voltage output is not turned off, since the existing image can be maintained.

FIG. 16A is a view showing another example of input voltage to a driver in scan mode and data mode, FIG. 16B is a view showing another example of correspondence in the case of driving cholesteric liquid crystal, FIG. 16C is a view showing another example of output voltage of a driver in the scan mode and the data mode, and FIG. 16D is a view showing another example of synthetic waveform applied to the liquid crystal.

As is evident from comparison of FIG. 16B with above-described FIG. 15B, in the case of the present example, same level of voltages 32V, 26V, 6V, 0V is inputted to each driver in data mode (SEG) and scan mode (COM). FIG. 16A is the same as FIG. 15A disclosed above.

As shown in FIG. 16C, output voltage of the scan driver at ON and OFF is such that ON-COM is 0V in the first half of AC drive and 32V in the second half of AC drive, and OFF-COM is 26V in the first half of AC drive and 6V in the second half of AC drive. Output voltage of the data driver at ON and OFF is such that ON-SEG is 32V in the first half of AC drive and 0V in the second half of AC drive, and OFF-SEG is 26V in the first half of AC drive and 6V in the second half of AC drive.

As shown in FIG. 16D, to the liquid crystal between each scan electrode and each data electrode (pixel), when selection of the liquid crystal is ON, pulse waveform of AC drive with 32V in the first half AV31 and −32V in the second half AV41 is applied, and when selection of the liquid crystal is OFF, pulse waveform of AC drive with 26V in the first half AV32 and −26V in the second half AV42 is applied. When non-selection of the liquid crystal is ON, pulse waveform of AC drive with 6V in the first half AV33 and −6V in the second half AV43 is applied, and when non-selection of the liquid crystal is OFF, pulse waveform of AC drive with 0V both in the first half AV34 and in the second half AV44 is applied.

Thus, by using input voltage levels for each driver common to data mode and scan mode, although the drive margin becomes a little narrower, voltage generating levels can be reduced to save power, and a voltage switching circuit can be omitted to save cost. Here, the drive margin can be increased, for example, by contrivance in element structure, etc.

Partial rewrite area is scanned, for example, at speed of about 10 msec./line, and non-target area where partial rewrite is not performed is scanned, for example, at speed of about μsec./line, so that scanning is accomplished in a moment. It is desirable to turn off the voltage output when non-target area is scanned.

As has been disclosed in the foregoing, when partial rewrite in existing display image is to be performed, writing (rewriting) process can be accomplished at higher speed by selecting the driver with smaller number of electrodes corresponding to the rewrite area as the scan driver.

The embodiment is not limited to cholesteric liquid crystal, but can be widely applied to electronic papers using, for example, electrophoresis or quick response liquid powder display, and electronic terminals having display device using same.

What is claimed is:

1. A method of driving a display element comprising a plurality of first electrodes and a plurality of second electrodes intersecting each other in mutually opposing state, and a display medium between each of said first electrodes and each of said second electrodes, said display element being driven by a first driver coupled to said first electrodes and a second driver coupled to said second electrodes, wherein:
one of said first and second drivers is used as a scan driver and the other of said first and second drivers is used as a data driver; and
in a partial rewrite area in an existing display image, the driver with smaller number of electrodes corresponding to said rewrite area is selected as said scan driver.

2. The method of driving a display element as claimed in 1, wherein an access to image data stored in a memory as well as data supplied to a driver selected as said data driver are converted, depending on whether one of said first and second drivers is selected as said scan driver or the other is selected as said scan driver.

3. The method of driving a display element as claimed in claim 1, wherein said scan driver scans the scan electrodes corresponding to said rewrite area at ordinary speed, and scans other scan electrodes at high speed.

4. The method of driving a display element as claimed in claim 1, wherein said scan driver and said data driver apply, to said display medium contained in said rewrite area, a voltage such that voltage difference between said first and second electrodes is not less than a response value voltage of said display medium, and apply, to said display medium not contained in said rewrite area, a voltage such that voltage difference between said first and second electrodes is less than said response value voltage of said display medium.

5. The method of driving a display element as claimed in claim 1, wherein input voltages to said scan driver and said data driver are made independent, and that the input voltages to said scan electrodes and said data electrodes are switched in accordance with switching of a scan direction.

6. The method of driving a display element as claimed in claim 1, wherein input voltages to said scan driver and said data driver are made common to both, and that the input voltages to said scan electrodes and said data electrodes are maintained as they are even if a scan direction is switched.

7. A display device comprising a display element having a plurality of first electrodes and a plurality of second electrodes intersecting each other in mutually opposing state, and a display medium between each of said first electrodes and each of said second electrodes, and a first driver coupled to said first electrodes and a second driver coupled to said second electrodes, wherein said display device comprises:
a driver selection circuit selecting one of said first and second drivers as a scan driver and the other of said first and second drivers as a data driver, and that said driver selection circuit selects, in a partial rewrite area in an existing display image, the driver with smaller number of electrodes corresponding to said rewrite area as said scan driver.

8. The display device as claimed in claim 7, wherein said device further comprises a data conversion circuit that converts an access to image data stored in a memory as well as data supplied to a driver selected as said data driver, depending on whether one of said first and second drivers is selected as said scan driver or the other is selected as said scan driver.

9. The display device as claimed in claim 7, wherein said scan driver scans the scan electrodes corresponding to said rewrite area at ordinary speed, and scans other scan electrodes at high speed.

10. The display device as claimed in claim 7, wherein said scan driver and said data driver apply, to said display medium contained in said rewrite area, a voltage such that voltage difference between said first and second electrodes is not less than a response value voltage of said display medium, and apply, to said display medium not contained in said rewrite area, a voltage such that voltage difference between said first and second electrodes is less than said response value voltage of said display medium.

11. The display device as claimed in claim 7, wherein input voltages to said scan driver and said data driver are made independent, and that the input voltages to said scan electrodes and said data electrodes are switched in accordance with switching of a scan direction.

12. The display device as claimed in claim 7, wherein input voltages to said scan driver and said data driver are made common to both, and that the input voltages to said scan electrodes and said data electrodes are maintained as they are even if a scan direction is switched.

13. The display device as claimed in claim 7, wherein said display medium has memory characteristics.

14. The display device as claimed in claim 13, wherein said display medium is a liquid crystal that forms a cholesteric phase.

15. The display device as claimed in claim 7, wherein said display element is a laminated structure of a plurality of display element units reflecting different light.

16. The display device as claimed in claim 15, wherein said scan driver and said data driver selectively drive said display element units to perform partial rewrite in accordance with a pattern of said rewrite area.

17. The display device as claimed in claim 15, wherein corresponding one of said first and second drivers of each of said display element units is made common.

18. The display device as claimed in claim 16, wherein monochromatic display is permitted in said rewrite area.

19. The display device as claimed in claim 7, wherein said first and second drivers are general purpose drivers for simple matrix.

20. An electronic terminal applying a display device which has a display element having a plurality of first electrodes and a plurality of second electrodes intersecting each other in mutually opposing state, and a display medium between each of said first electrodes and each of said second electrodes, and a first driver coupled to said first electrodes and a second driver coupled to said second electrodes, wherein said display device comprises:
a driver selection circuit selecting one of said first and second drivers as a scan driver and the other of said first and second drivers as a data driver, and that said driver selection circuit selects, in a partial rewrite area in an existing display image, the driver with smaller number of electrodes corresponding to said rewrite area as said scan driver.
